(19) United States
(12) Patent Application Publication
(10) Pub. No.: US 2014/0187691 A1
(43) Pub. Date: Jul. 3, 2014

(54) Flame Retardant Polyamide Resin Composition and Molded Article Comprising the Same

(71) Applicant: Cheil Industries Inc., Gumi-si (KR)

(72) Inventors: Seung Woo JANG, Uiwang-si (KR); Chang Hong KO, Uiwang-si (KR); Min Soo LEE, Uiwang-si (KR); Sung Hee AHN, Uiwang-si (KR)

(73) Assignee: Cheil Industries Inc., Gumi-si (KR)

(21) Appl. No.: 14/103,877

(22) Filed: Dec. 12, 2013

(30) Foreign Application Priority Data
Dec. 28, 2012 (KR) 10-2012-0157677
Jun. 5, 2013 (KR) 10-2013-0065013

(51) Int. Cl. C08L 77/06

(52) U.S. Cl. CPC C08L 77/06
USPC 524/133; 524/538

(57) ABSTRACT

A flame retardant includes a polymer including a unit represented by Formula 1:

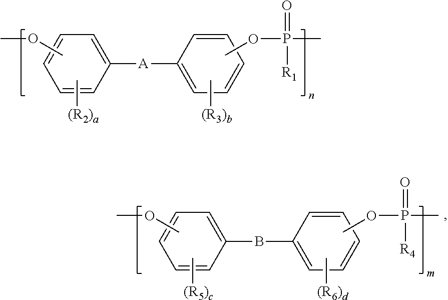

wherein A and B are each independently a single bond, C₁ to C₅ alkylene, C₁ to C₅ alkylidene, C₅ to C₆ cycloalkylidene, —S— or —SO₂—, provided that A and B are different from each other; R₁ and R₄ are each independently substituted or unsubstituted C₁ to C₆ alkyl, substituted or unsubstituted C₆ to C₂₀ aryl, or substituted or unsubstituted C₆ to C₂₀ aryloxy; R₂, R₃, R₅ and R₆ are each independently substituted or unsubstituted C₁ to C₆ alkyl, substituted or unsubstituted C₃ to C₆ cycloalkyl, substituted or unsubstituted C₆ to C₁₂ aryl, or halogen; a, b, c and d are each independently an integer from 0 to 4; m is an integer from 0 to 500; and n is an integer from 1 to 500. The flame retardant polyamide resin composition can have excellent flame retardancy and can maintain crystallinity.

### CROSS-REFERENCE TO RELATED APPLICATION

This application claims priority under 35 USC Section 119 to and the benefit of Korean Patent Application No. 10-2012-0157677, filed Dec. 28, 2012, and Korean Patent Application No. 10-2013-0065013, filed Jun. 5, 2013, the entire disclosure of each of which is incorporated herein by reference.

### FIELD OF THE INVENTION

The present invention relates to a flame retardant polyamide resin composition and a molded article including the same.

### BACKGROUND OF THE INVENTION

Polyamide resins have excellent properties in terms of heat resistance, machinability, and the like, and thus, are widely used in various fields including automotive components, electrical and electronic products, components of machinery, and the like. However, since unmodified polyamide resin compositions are not suitable for use in electrical and electronic applications due to inherently poor flame retardancy thereof, a flame-retardant polyamide resin composition including a flame retardant is used in electrical and electronic applications which require both excellent machinability and flame retardancy.

Polyamide resin compositions employing halogen flame retardants may exhibit suitable flame retardancy. However, with increasing interest in environmental issues, regulations on existing halogen flame-retardants have been increasingly reinforced in many countries. As such, there is a need for polyamide resin compositions including non-halogen flame retardants instead of halogen flame retardants. Currently, a commercially applicable non-halogen flame retardant polyamide resin composition includes a metal salt of phosphinic acid as a flame retardant.

However, a phosphinic acid metal salt-based flame-retardant can exhibit low dispersibility in a polyamide resin composition. In addition, the phosphinic acid metal salt-based flame-retardant can cause embrittlement of finished products and corrosion of plastic screw extruders. As a solution to such problems, attempts have been made to develop a highly heat resistant flame retardant which imparts an initial decomposition temperature (T_{id}) of 350° C. or higher when applied to a polyamide resin. Although such a highly heat resistant flame retardant can provide suitable flame retardancy, the flame retardant causes deterioration in physical properties, for example, loss of crystallinity of a polyamide resin and the like.

Therefore, there is a need for polyamide resin compositions that exhibit excellent properties in terms of flame retardancy and mechanical properties without deteriorating dispersibility and crystallinity, when containing a non-halogen flame retardant.

### SUMMARY OF THE INVENTION

The present invention provides a flame retardant polyamide resin composition that can exhibit excellent properties in terms of flame retardancy, tensile strength, tensile elongation, flexural strength, flexural modulus and/or impact resistance without suffering from deterioration in crystallinity, and a molded article including the same.

The flame retardant polyamide resin includes: a polyamide resin; a filler; a flame retardant; and a polyphenylene sulfide resin. As used herein, the flame retardant includes a polymer including a unit represented by Formula 1:

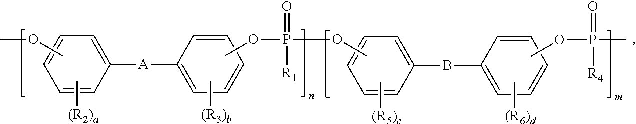

wherein A and B are each independently a single bond, C₁ to C₅ alkylene, C₂ to C₅ alkylidene, C₅ to C₆ cycloalkylidene, —S— or —SO₂—, provided that A and B are different from each other; R₁ and R₄ are the same or different and are each independently substituted or unsubstituted C₁ to C₆ alkyl, substituted or unsubstituted C₆ to C₂₀ aryl, or substituted or unsubstituted C₆ to C₂₀ aryloxy; R₂, R₃, R₅ and R₆ are the same or different and are each independently substituted or unsubstituted C₁ to C₆ alkyl, substituted or unsubstituted C₃ to C₆ cycloalkyl, substituted or unsubstituted C₆ to C₁₂ aryl, or halogen; a, b, c and d are the same or different and are each independently an integer from 0 to 4; m is an integer from 0 to 500; and n is an integer from 1 to 500.

In one embodiment, the flame retardant polyamide resin includes about 100 parts by weight of the polyamide resin, about 1 part by weight to about 150 parts by weight of the filler, about 0.5 parts by weight to about 30 parts by weight of the flame retardant, and about 1 part by weight to about 40 parts by weight of the polyphenylene sulfide resin.

In one embodiment, the flame retardant may further include a phosphorus compound. The phosphorus compound may include a metal salt of phosphinic acid. A weight ratio of the flame retardant polymer including a unit represented by Formula 1 to the phosphorus compound (polymer:phosphorus compound) may be about 1:about 0.05 to about 1:about 20.

In one embodiment, the polyamide resin may be a polymer of a dicarboxylic acid component including a C₈ to C₂₀ aromatic dicarboxylic acid and a diamine component including a C₄ to C₂₀ aliphatic diamine.

In one embodiment, the filler may include at least one of organic fillers and inorganic fillers.

The organic filler may include aramid fibers, and the inorganic fillers may include at least one of fibrous fillers including at least one of carbon fibers, glass fibers, alkaline earth metal titanate fibers, silicon carbide fibers, and wollastonite; and powdery fillers including at least one of calcium carbide, silica, titanium oxide, carbon black, alumina, lithium carbonate, iron oxide, molybdenum bisulfide, graphite, glass beads, talc, clay micas, zirconium oxide, calcium silicate, and boron nitride.

In one embodiment, the sum of m and n may range from 3 to 600.

The metal salt of phosphinic acid may include at least one of compounds represented by Formulae 2 and 3:

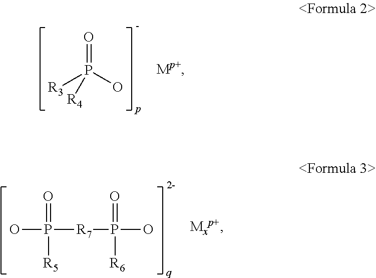

wherein R₃, R₄, R₅ and R₆ are the same or different and are each independently substituted or unsubstituted C₁ to C₆ alkyl, substituted or unsubstituted C₃ to C₆ cycloalkyl, or substituted or unsubstituted C₆ to C₁₂ aryl; R₇ is C₁ to C₁₀ alkylene or C₆ to C₁₀ arylene, C₁ to C₆ alkyl-C₆ to C₁₀ arylene, or C₆ to C₁₀ aryl-C₆ to C₁₀ alkylene; M is Al, Zn, Ca or Mg; p is 2 or 3; q is 1 or 3; and x is 1 or 2.

The metal salt of phosphinic acid may include at least one of aluminum diethyl phosphinate and aluminum methylethyl phosphinate.

In one embodiment, the flame retardant polyamide resin composition may have a flame retardancy level of V-0 or higher, as measured on a 0.8 mm thick specimen in accordance with UL94 VB.

In one embodiment, the flame retardant polyamide resin composition may have a melting point (Tm) of about 280° C. to about 320° C. and a crystallization temperature (Tc) of about 250° C. to about 290° C.

The present invention also relates to a molded article produced from the flame-retardant polyamide resin composition.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A flame retardant polyamide resin composition according to the present invention includes (A) a polyamide resin, (B) fillers, (C) a flame retardant, and (D) a polyphenylene sulfide resin.

(A) Polyamide Resin

In the present invention, the polyamide resin may be selected from any typical polyamide resin which mainly includes amino acid, lactam, dicarboxylic acid, diamine components, and the like. For example, the polyamide resin may have a repeat structure of dicarboxylic acid moieties and diamine moieties obtained through polymerization of a dicarboxylic acid component including an aromatic dicarboxylic acid component and a diamine component including an aliphatic diamine component, wherein the dicarboxylic acid moieties are derived from the dicarboxylic acid component and the diamine moieties are derived from the diamine component.

As used herein, the term “dicarboxylic acid component” refers to dicarboxylic acids and derivatives thereof, such as alkyl esters thereof (C₁ to C₄ lower alkyl esters, such as monomethyl, monoethyl, dimethyl, diethyl or dibutyl esters), acid anhydrides thereof, and the like, and combinations thereof, that form the dicarboxylic acid moieties through reaction with a diamine component. In addition, as used herein, the dicarboxylic acid moieties and the diamine moieties refers to residues, from which a hydrogen atom, hydroxyl group and/or alkoxy group is removed upon polymerization of the dicarboxylic acid component and the diamine component.

In one embodiment, the dicarboxylic acid component may be a compound including at least one C₈ to C₂₀ aromatic dicarboxylic acid component. Examples of the dicarboxylic acid component may include without limitation terephthalic acid, isophthalic acid, 2,6-naphthalene dicarboxylic acid, 2,7-naphthalene dicarboxylic acid, 1,4-naphthalene dicarboxylic acid, 1,4-phenylene dioxydiphenolic acid, 1,3-phenylene dioxydiacetic acid, diphenic acid, 4,4′-oxybis(benzoic acid), diphenylmethane-4,4′-dicarboxylic acid, diphenylsulfone-4,4′-dicarboxylic acid, 4,4′-diphenyldicarboxylic acid, and the like, and mixtures thereof. For example, the dicarboxylic acid component may be terephthalic acid, isophthalic acid or a mixture thereof. In exemplary embodiments, the dicarboxylic acid component may be terephthalic acid, or a mixture of terephthalic acid and isophthalic acid.

In one embodiment, the diamine component may include at least one C₄ to C₂₀ aliphatic diamine component. Examples of the diamine component may include without limitation linear aliphatic diamines, such as 1,4-butanediamine, 1,6-hexanediamine (hexamethylene diamine), 1,7-heptanediamine, 1,8-octanediamine, 1,9-nonanediamine, 1,10-decanediamine, 3-methyl-1,5 -pentanediamine, 2,2,4-trimethyl-1,6-hexanediamine, 2,4,4-trimethyl-1,6-hexanediamine, 5-methyl-1,9-nonanediamine, 2,2′-oxybis(ethylamine), bis(3-aminopropyl)ether, ethylene glycol bis(3-aminopropyl)ether (EGBA), 1,7-diamino-3,5-dioxoheptane, and the like, and mixtures thereof. For example, the diamine component may be 1,4-butanediamine, 1,6-hexanediamine, or a mixture thereof. In exemplary embodiments, the diamine component may be 1,6-hexanediamine.

Optionally, the diamine component may further include another diamine component selected from among cycloaliphatic diamines, such as cyclohexyldiamine, methylcyclohexyldiamine, bis(p-cyclohexyl)methanediamine, bis(aminomethyl)norbornan, bis(aminomethyl)tricyclodecane, bis(aminomethyl)cyclohexane, and the like, aromatic diamines, such as p-phenylenediamine, m-phenylenediamine, xylenediamine, 4,4′-diaminodiphenylsulfone, 4,4′-diaminodiphenylethre, and the like, and mixtures thereof.

The diamine component may include the aliphatic diamine component in an amount of, for example, about 60 mol % or more, for example about mol % 70 to about 95 mol %. In some embodiments, the diamine component may include the aliphatic diamine component in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 mol %. Further, according to some embodiments of the present invention, the amount of the aliphatic diamine component can be in a range from about any of the foregoing amounts to about any other of the foregoing amounts.

The diamine component may include another diamine component (such as the cycloaliphatic and/or aromatic diamine) in an amount of about 40 mol % or less, for example about 5 mol % to about 30 mol %, without being limited thereto. In some embodiments, the diamine component may include the other diamine component in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mol %. Further, according to some embodiments of the present invention, the amount of the other diamine component can be in a range from about any of the foregoing amounts to about any other of the foregoing amounts.

In this invention, the polyamide resin may be prepared through any typical method of preparing a polyamide resin, such as melt polymerization and the like.

For example, in preparation of the polyamide resin, the ratio of the dicarboxylic acid component to the diamine component (molar ratio: diamine component/dicarboxylic acid component) may range from about 0.85 to about 1.05, for example, from about 0.90 to about 1.03. Within this range, it is possible to prevent deterioration in properties due to unreacted monomers.

In addition, the polyamide resin may have a terminal group encapsulated with an end capping agent. Examples of the end capping agent may include without limitation aliphatic carboxylic acids, aromatic carboxylic acids, and the like and mixtures thereof. Examples of the end capping agent may include without limitation acetic acid, propionic acid, butyric acid, valeric acid, caproic acid, caprylic acid, lauric acid, tridecanoic acid, myristic acid, palmitic acid, stearic acid, pivalic acid, isobutyric acid, benzoic acid, toluic acid, α-naphthalene carboxylic acid, β-naphthalene carboxylic acid, methylnaphthalene carboxylic acid, and the like, and mixtures thereof. The end capping agent is optionally present in an amount of, for example, about 0.01 parts by mole to about 5 parts by mole, for example about 0.1 parts by mole to about 3 parts by mole, based on about 100 parts by mole of the dicarboxylic acid component and the diamine component.

The polyamide resin may have a weight average molecular weight (Mw) from about 10,000 g/mol to about 70,000 g/mol, for example from about 15,000 g/mol to about 40,000 g/mol, as measured by gel permeation chromatography (GPC). Within this range, the polyamide resin can exhibit excellent mechanical properties.

(B) Filler

In the present invention, typical fillers used in a flame retardant thermoplastic resin composition may be used. Examples of the fillers may include without limitation organic fillers, inorganic fillers, and the like, and mixtures thereof. Examples of the organic fillers may include without limitation aramid fibers. Examples of the inorganic fillers may include without limitation fibrous fillers such as carbon fibers, glass fibers, alkaline earth metal titanate fibers, silicon carbide fibers, wollastonite, and the like; powdery fillers such as calcium carbide, silica, titanium oxide, carbon black, alumina, lithium carbonate, iron oxide, molybdenum bisulfide, graphite, glass beads, talc, clay micas, zirconium oxide, calcium silicate, boron nitride, and the like; and mixtures thereof.

When the fillers are fibrous fillers, the fillers may have a diameter of about 5 μm to about 30 μm and a length of about 1 mm to about 25 mm, without being limited thereto.

The flame retardant polyamide resin composition may include the filler in an amount of about 1 to about 150 parts by weight, for example about 20 parts by weight to about 110 parts by weight, and as another example about 30 parts by weight to about 100 parts by weight, based on about 100 parts by weight of the polyamide resin. In some embodiments, the flame retardant polyamide resin composition may include the filler in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150 parts by weight. Further, according to some embodiments of the present invention, the amount of the filler can be in a range from about any of the foregoing amounts to about any other of the foregoing amounts.

When the resin composition includes the filler in an amount within this range, the resin composition can exhibit excellent mechanical properties and flame retardancy.

(C) Flame Retardant

In the present invention, the flame retardant may enhance flame retardancy without deterioration in crystallinity of the resin composition, and may include a polymer including a unit represented by Formula 1.

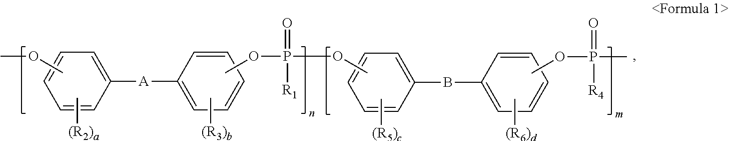

wherein A and B are each independently a single bond, C₁ to C₅ alkylene, C₁ to C₅ alkylidene, C₅ to C₆ cycloalkylidene, —S— or —SO₂—, provided that A and B are different from each other; R₁ and R₄ are the same or different and are each independently substituted or unsubstituted C₁ to C₆ alkyl, substituted or unsubstituted C₆ to C₂₀ aryl, or substituted or unsubstituted C₆ to C₂₀ aryloxy; R₂, R₃, R₅ and R₆ are the same or different and are each independently substituted or unsubstituted C₁ to C₆ alkyl, substituted or unsubstituted C₃ to C₆ cycloalkyl, substituted or unsubstituted C₆ to C₁₂ aryl, or halogen; a, b, c and d are the same or different and are each independently an integer from 0 to 4; m is an integer from 0 to 500, for example from 1 to 500; and n is an integer from 1 to 500, for example from 4 to 500.

In one embodiment, the sum of m and n may range from 3 to 600. Within this range, the resin composition can exhibit better flame retardancy.

As used herein, the term “substituted” means that a hydrogen atom is substituted by a substituent such as C₁ to C₁₀ alkyl, C₆ to C₁₈ aryl, halogen, or a combination thereof. In exemplary embodiments, the substituent may be C₁ to C₆ alkyl, for example, C₁ to C₃ alkyl.

In one embodiment, as the polymer including the unit represented by Formula 1, for example, homopolymer type polyphosphonate or copolymer type polyphosphonate may be used alone or in combination thereof, without being limited thereto.

The polymer may be prepared by reacting, for example, a diol represented by the following Formula 1a with the phosphonic dichloride represented by the following Formula 1b.

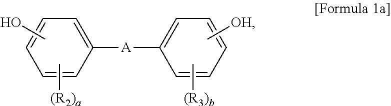

wherein A, R₂, R₃, a and b are the same as defined in Formula 1.

Examples of the diol may include without limitation 4,4′-dihydroxybiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like, and mixtures thereof. In exemplary embodiments, the diol may be 4,4′-dihydroxybiphenyl and/or 2,2-bis-(4-hydroxyphenyl)-propane.

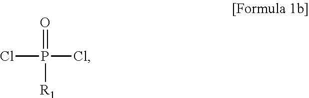

wherein R₁ is the same as defined in Formula 1.

Each of the diol represented by Formula 1a and the phosphonic dichloride represented by Formula 1b may include two or more compounds wherein A, R₁, R₂, R₃, a and b of one compound are different from those of the other compound, and may indicate B, R₄, R₅, R₆, c and d of the polyphosphonate including the unit represented by Formula 1 upon polymerization. In addition, the polymer may include at least one copolymer type polyphosphonate prepared from the two or more compounds.

In one embodiment, the polymer may be prepared by dropping the phosphonic dichloride into a solution in which the diol, a catalyst and the end capping agent are mixed. For example, the phosphonic dichloride may be reacted in an amount of about 1 equivalent weight with respect to a total of about 1 equivalent weight of the diol, and the reaction between the diol and the phosphonic dichloride may be performed by typical polymerization in the presence of a Lewis acid catalyst.

Examples of the Lewis acid catalyst may include aluminum chloride and/or magnesium chloride, without being limited thereto. Relative to about 1 equivalent weight of the diol, the catalyst may be used in an amount of about 0.01 to about 10 equivalent weights, for example about 0.01 to about 1 equivalent weight, without being limited thereto

The end capping agent may include a C₁ to C₅ alkyl group-containing phenol, for example, phenol, 4-tert-butylphenol, 2-tert-butylphenol, and the like, and mixtures thereof. The end capping agent may be used in an amount of about 1 equivalent weight or less, for example about 0.01 to about 0.5 equivalent weights, relative to about 1 equivalent weight of the diol, without being limited thereto.

In one embodiment, the flame retardant may be washed with an acid solution after completion of the reaction. The acid solution may include phosphoric acid, hydrochloric acid, nitric acid, sulfuric acid, and the like, for example phosphoric acid and/or hydrochloric acid. The acid solution may have a concentration of about 0.1% to about 10%, for example about 1% to about 5%. Then, a white solid phosphorus flame retardant may be obtained through washing and filtration.

The polymer may have a weight average molecular weight of about 1,000 g/mol to about 50,000 g/mol as measured by gel permeation chromatography (GPC). In exemplary embodiments, the polymer may have a weight average molecular weight of about 1,000 g/mol to about 20,000 g/mol, for example about 1,000 g/mol to about 10,000 g/mol. Within this range, the resin composition can exhibit excellent flame-retardancy.

The polymer may have an acid value of about 0.005 4 KOH mg/g to about 4 KOH mg/g, for example about 0.01 KOH mg/g to about 1 KOH mg/g. Within this range, the thermoplastic resin does not suffer from decomposition.

According to the invention, the flame retardant may further include a phosphorus compound.

In one embodiment, the phosphorus compound may be any phosphorus compound typically used as a flame retardant. Examples of the phosphorus compound may include without limitation red phosphorus, phosphate, phosphonate, phosphinate, phosphine oxide, phosphazene, metal salts thereof, and the like, and mixtures thereof. In exemplary embodiments, the phosphorus compound may be a metal salt of phosphinic acid.

The metal salt of phosphinic acid may include, for example, at least one of compounds represented by Formulae 2 and/or 3:

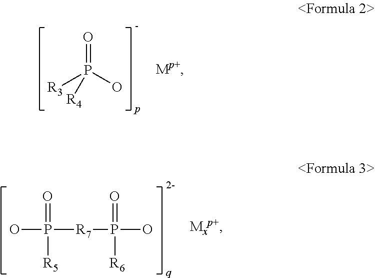

wherein R₃ to R₆ are the same or different and are each independently substituted or unsubstituted C₁ to C₆ alkyl, substituted or unsubstituted C₃ to C₆ cycloalkyl, or substituted or unsubstituted C₆ to C₁₂ aryl, for example, methyl, ethyl, propyl, isopropyl, butyl, pentyl, phenyl, and the like; R₂ is C₁ to C₁₀ alkylene or C₆ to C₁₀ arylene, alkyl-arylene or aryl-alkylene, for example, methylene, ethylene, propylene, butylene, pentylene, octylene, dodecylene, phenylene, naphthylene, methyl phenylene, ethyl phenylene, butyl phenylene, methyl naphthylene, ethyl naphthylene, butyl naphthylene, phenyl methylene, phenyl ethylene, phenyl propylene, and phenyl butylene; M is Al (aluminum), Zn (zinc), Ca (calcium) or Mg (magnesium), for example Al or Zn; p is 2 or 3; q is 1 or 3; and x is 1 or 2.

Examples of the metal salt of phosphinic acid may include without limitation aluminum diethyl phosphinate, aluminum methylethyl phosphinate, and the like, and mixtures thereof.

When the phosphorus compound is included in the flame retardant, the weight ratio of the flame retardant polymer including a unit represented by Formula 1 to the phosphorus compound (polymer:phosphorus compound) may range from about 1:about 0.05 to about 1:about 20, for example from about 1:about 0.1 to about 1:about 15, and as another example from about 1:about 0.3 to about 1:about 10. Within this range, the flame retardant polyamide resin composition can exhibit improved flame retardancy without suffering deterioration in crystallinity.

The flame retardant polyamide resin composition may include the flame retardant in an amount of about 0.5 parts by weight to about 30 parts by weight, for example about 1 part by weight to about 25 parts by weight, and as another example about 5 to about 20 parts by weight, based on about 100 parts by weight of the polyamide resin. In some embodiments, the flame retardant polyamide resin composition may include the flame retardant in an amount of about 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the flame retardant can be in a range from about any of the foregoing amounts to about any other of the foregoing amounts.

When the flame retardant polyamide resin composition includes the flame retardant in an amount within this range, the flame retardant polyamide resin composition can exhibit improved flame retardancy without suffering deterioration in crystallinity, and can exhibit an excellent balance between flame retardancy and mechanical properties.

(D) Polyphenylene Sulfide Resin

In the present invention, the polyphenylene sulfide resin may improve properties of the flame retardant polyamide resin composition, such as crystallinity, heat resistance, strength and the like, and may be selected from typical polyphenylene sulfide resins. For example, the polyphenylene sulfide resin may include a repeat unit represented by Formula 4.

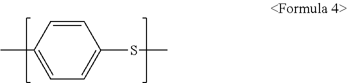

In addition, optionally, the polyphenylene sulfide resin may further include one or more repeat units represented by Formulae 5a to 5h.

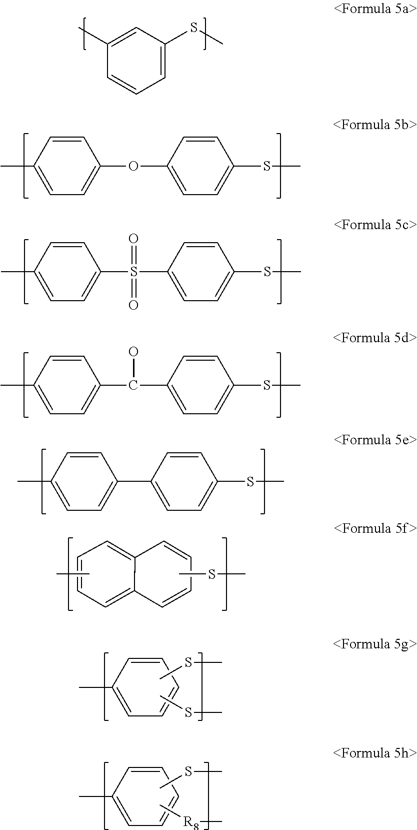

In Formula 5h, R₈ is C₁ to C₁₀ alkylene, C₆ to C₁₂ arylene, C₁ to C₁₀ alkylene oxide, —COO—, —CO—, or —SO₂—.

The repeat unit represented by Formulae 5a to 5h may be present in an amount of less than about 50 mol %, for example less than about 30 mol % in the polyphenylene sulfide resin which includes the repeat unit represented by Formula 4. Within this range of the polyphenylene sulfide resin, the flame retardant polyamide resin composition can exhibit excellent crystallinity, heat resistance, and the like.

According to preparation methods, the polyphenylene sulfide resin may be classified into a linear molecular structure type and/or a branched or crossed molecular structure type. For example, a method of preparing the branched or crossed polyphenylene sulfide resin is disclosed in Japanese Patent Laid-open Publication No. S45-3368A and a method of preparing the linear polyphenylene sulfide resin is disclosed in Japanese Patent Laid-open Publication No. S52-12240, the entire disclosure of each of which is incorporated herein by reference.

In consideration of thermal stability or processability, the polyphenylene sulfide resin may have a melt index of about 10 g/min to about 300 g/10 min at 316° C. under a load of 2.16 kg. Within this range, the polyphenylene sulfide resin can exhibit excellent kneading capabilities without deterioration in strength and can secure processability upon injection molding.

The flame retardant polyamide resin composition may include the polyphenylene sulfide resin in an amount of about 1 part by weight to about 40 parts by weight, for example about 5 parts by weight to about 30 parts by weight, and as another example about 10 parts by weight to about 25 parts by weight, based on about 100 parts by weight of the polyamide resin. In some embodiments, the flame retardant polyamide resin composition may include the polyphenylene sulfide resin in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 parts by weight. Further, according to some embodiments of the present invention, the amount of the polyphenylene sulfide resin can be in a range from about any of the foregoing amounts to about any other of the foregoing amounts.

When the flame retardant polyamide resin composition includes the polyphenylene sulfide resin in an amount within this range, the polyphenylene sulfide resin can improve crystallinity, heat resistance and strength of the resin composition without deterioration of other properties.

According to the invention, the flame retardant polyamide resin composition may further include one or more additives. Examples of the additives can include without limitation flame retardant aids, lubricants, plasticizers, heat stabilizers, anti-dripping agents, antioxidants, compatibilizers, light stabilizers, pigments, dyes, inorganic additives, and the like, as needed. These may be used alone or in combination thereof.

According to the invention, the flame retardant polyamide resin composition may have improved flame retardancy using a non-halogen flame retardant without deterioration in crystallinity. The flame retardant polyamide resin composition may have a flame retardancy level of V-0 or higher, as measured on an about 0.8 mm thick specimen in accordance with the UL-94 VB standard. In addition, the flame retardant polyamide resin composition may have a melting point (Tm) from about 280° C. to about 320° C., for example from about 290° C. to about 310° C., and a crystallization temperature (Tc) from about 250° C. to about 290° C., for example from about 260° C. to about 280° C. Here, the crystallization temperature and the melting point were measured using a differential scanning calorimeter (DSC) and a thermogravimetric analyzer (TGA).

The present invention also relates to a molded article produced from the flame-retardant polyamide resin composition.

The flame retardant polyamide resin composition may be prepared in pellet form by melt extrusion in an extruder after mixing all of the above components and other optional additives. The pelletized resin composition may be used to produce various molded articles through molding methods, such as injection molding, extrusion molding, vacuum molding, cast molding, and the like. These articles can be easily produced by those skilled in the art.

Since the molded article can have excellent properties in terms of flame retardancy, crystallinity, tensile strength, tensile elongation, flexural strength, flexural modulus, impact resistance, and the like, the molded article may be widely applied to components of electric and electronic products, exterior materials, automobile parts, miscellaneous goods, structural materials, and the like.

Next, the present invention will be explained in more detail with reference to the following examples. However, it should be understood that these examples are provided for illustration only and are not to be in any way construed as limiting the present invention.

### EXAMPLES

Details of components used in the following examples and comparative examples are as follows.

(a) Polyamide Resin

Zytel HTN 501 (DuPont) is used.

(B) Filler

A glass fiber filler (CS 910-10P 3 MM, Saint-Gobain Vetrotex) is used.

(C) Flame Retardant

(C1) Polymer

(C1-1) 15 kg of 2,2-bis-(4-hydroxyphenyl)-propane as a diol, 2.0 kg of 4-tert-butylphenol as an end capping agent, and 0.4 kg of aluminum chloride as a catalyst are added to 90 L of chlorobenzene, and the temperature of the reactor is increased to 131° C. Then, 13.5 kg of phenyl phosphonic acid dichloride is added as the phosphonic dichloride to initiate reaction. Next, the mixture is stirred for 8 hours. After completion of the reaction, the resulting material is cooled to 80° C., and washed with 90 kg of 10% aqueous hydrochloric acid solution, followed by washing with 90 kg of purified water twice. After washing, a water layer is removed from the resulting material, and an organic layer is removed therefrom through vacuum distillation, thereby obtaining 20 kg of a polymer. The prepared polymer has a weight average molecular weight of 2,400 g/mol, PDI of 1.4, and an acid value of 0.2 KOH mg/g.

(C1-2) 15 kg of 2,2-bis-(4-hydroxyphenyl)-propane and 4,4′-dihydroxybiphenyl in a molar ratio of 1:1 as a diol, 2.0 kg of 4-tert-butylphenol as an end capping agent, and 0.4 kg of aluminum chloride as a catalyst are added to 90 L of chlorobenzene, and the temperature of the reactor is increased to 131° C. Then, 13.5 kg of phenyl phosphonic acid dichloride is added as the phosphonic dichloride to initiate reaction. Next, the mixture is further stirred for 8 hours. After completion of the reaction, the resulting material is cooled to 80° C., and washed with 90 kg of 10% hydrochloric acid aqueous solution, followed by washing with 90 kg of purified water twice. After washing, a water layer is removed from the resulting material, and an organic layer is removed therefrom through vacuum distillation, thereby obtaining 20 kg of a polymer. The prepared polymer has a weight average molecular weight of 2,600 g/mol, PDI of 1.5, and an acid value of 0.2 KOH mg/g.

(C2) Phosphorus Compound

(C2-1) Aluminum diethylphosphinate (Exolit OP-930, Clariant) is used.

(C2-2) Aluminum diethylphosphinate (Exolit OP-1240, Clariant) is used.

(C2-3) As a single molecular type phosphorus compound, bisphenol A diphosphate (CR-741S, Daihachi Chemical Industry Co., Ltd.) is used.

(D) Polyphenylene Sulfide Resin

A crosslinking type polyphenylene sulfide resin (PPS-hb(cross type), Sichuan Deyang Chemical Co., Ltd) is used.

### Examples 1 to 7 and Comparative Examples 1 to 2

The components are mixed in amounts as listed in Table 1, followed by melting, kneading and extrusion to prepare pellets. Extrusion is performed using a twin-screw extruder, and the prepared pellets are dried at 100° C. for 4 hours and subjected to injection molding at a molding temperature of 320° C. and a mold temperature of 130° C. to prepare specimens. Properties of the prepared specimens are evaluated by the following methods, and results are shown in Table 2.

TABLE 1
(Unit: parts by weight)

| | | | | | | | | | Comparative | |
|---|---|---|---|---|---|---|---|---|---|---|
| | | Example | | | | | | | Example | |
| | | 1 | 2 | 3 | 4 | 5 | 6 | 7 | 1 | 2 |
| (A) | | 100 | 100 | 100 | 100 | 100 | 100 | 100 | 100 | 100 |
| (B) | | 99.3 | 99.3 | 99.3 | 99.3 | 99.3 | 99.3 | 99.3 | 99.3 | 99.3 |
| (C1) | (C1-1) | 9.9 | 9.9 | 9.9 | — | — | — | — | — | — |
| | (C1-2) | — | — | — | 4.95 | 9.9 | 9.9 | 9.9 | — | — |
| (C2) | (C2-1) | 9.9 | 4.95 | — | 9.9 | 9.9 | 4.95 | — | 9.9 | — |
| | (C2-2) | — | 4.95 | 9.9 | 4.95 | — | 4.95 | 9.9 | 9.9 | — |
| | (C2-3) | — | — | — | — | — | — | — | — | 19.8 |

| | | | | | | | | | |
|---|---|---|---|---|---|---|---|---|---|
| (D) | 25.4 | 25.4 | 25.4 | 25.4 | 25.4 | 25.4 | 25.4 | 25.4 | 25.4 |

Evaluation of Properties

(1) Flame retardancy is measured on a 0.8 mm thick specimen in accordance with the UL-94 VB standard.

(2) Melting point (Tm), crystallization temperature (Tc) (unit: ° C.), and enthalpy of crystallization (unit: J/g) are measured using a differential scanning calorimeter (DSC). A model Q20 tester (TA) is used as the DSC, and measurement is performed under a nitrogen atmosphere at a heating rate of 10° C./min and a cooling rate of 10° C./min from 30° C. to 400° C. Here, the crystallization temperature and the enthalpy of crystallization are determined by a maximum point of exothermic peaks upon cooling, and the melting point is determined by a maximum point of endothermic peaks upon heating.

(3) Tensile elongation (unit: %) and tensile strength (unit: kgf/cm²) are measured under conditions of 5 mm/min in accordance with ASTM D-638.

(4) Flexural modulus and flexural strength (unit: kgf/cm²) are measured under conditions of 2.8 mm/min in accordance with ASTM D-790.

(5) Izod impact strength (unit: kgf cm/cm) is measured on a ⅛″ thick notched specimen in accordance with ASTM D-256.

(6) Viscosity was measured in accordance with ASTM D-792.

TABLE 2

| | | | | | | | | Comparative | |
|---|---|---|---|---|---|---|---|---|---|
| | Example | | | | | | | Example | |
| | 1 | 2 | 3 | 4 | 5 | 6 | 7 | 1 | 2 |
| Flame Retardancy | V-0 | V-0 | V-0 | V-0 | V-0 | V-0 | V-0 | V-0 | V-2 |
| Tm (° C.) | 297.2 | 296.2 | 296.3 | 298.0 | 297.7 | 296.8 | 296.3 | 298.8 | — |
| Tc (° C.) | 268.6 | 268.6 | 266.4 | 266.9 | 266.5 | 266.6 | 267.3 | 256.1 | — |
| Enthalpy of | 12.8 | 12.8 | 12.5 | 11.3 | 12.6 | 11.9 | 12.0 | 14.2 | — |
| Crystallization | | | | | | | | | |
| (J/g) | | | | | | | | | |
| Tensile Elongation | 3.6 | 3.5 | 3.6 | 3.6 | 3.3 | 3.5 | 3.5 | 3.3 | 2.9 |
| (%) | | | | | | | | | |
| Tensile Strength | 1834 | 1795 | 1883 | 1870 | 1775 | 1815 | 1832 | 1686 | 1473 |
| (kgf/cm²) | | | | | | | | | |
| Flexural Modulus | 131,800 | 129,700 | 136,800 | 130,100 | 138,600 | 135,500 | 134,500 | 126,800 | 103,400 |
| (kgf/cm²) | | | | | | | | | |
| Flexural Strength | 2201 | 2316 | 2278 | 2367 | 2132 | 2141 | 2149 | 2118 | 1764 |
| (kgf/cm²) | | | | | | | | | |
| Impact Strength | 7.51 | 7.59 | 7.54 | 8.1 | 7.4 | 7.6 | 7.6 | 7.27 | 3.9 |
| (kgf · cm/cm) | | | | | | | | | |

In Table 2, it can be seen that the flame retardant polyamide resin compositions (Examples 1 to 7) according to the present invention exhibit excellent flame retardancy without deteriorating crystallinity according to the measured Tc and enthalpy of crystallization, and also exhibit excellent properties in terms of tensile strength, tensile elongation, flexural strength, flexural modulus, and impact resistance, thereby providing an excellent balance of properties.

In contrast, in Comparative Example 2 wherein only the single molecule type phosphorus compound is used as the flame retardant, Tm, Tc and enthalpy of crystallization are not measured, and it is considered that this result is caused by obstruction of crystallization of Nylon by the single molecule type phosphorus compound. In Comparative Example 1 wherein only the metal salt of phosphinic acid is used as the flame retardant, the resin composition has deteriorated flame retardancy and property balance.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flame retardant polyamide resin composition comprising: a polyamide resin; a filler; a flame retardant; and a polyphenylene sulfide resin,
wherein the flame retardant comprises a polymer including a unit represented by Formula 1: 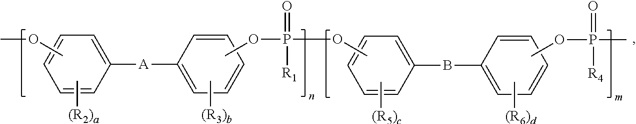
wherein A and B are each independently a single bond, C₁ to C₅ alkylene, C₁ to C₅ alkylidene, C₅ to C₆ cycloalkylidene, —S— or —SO₂—, provided that A and B are different from each other; R₁ and R₄ are the same or different and are each independently substituted or unsubstituted C₁ to C₆ alkyl, substituted or unsubstituted C₆ to C₂₀ aryl, or substituted or unsubstituted C₆ to C₂₀ aryloxy; R₂, R₃, R₅ and R₆ are the same or different and are each independently substituted or unsubstituted C₁ to C₆ alkyl, substituted or unsubstituted C₃ to C₆ cycloalkyl, substituted or unsubstituted C₆ to C₁₂ aryl, or halogen; a, b, c and d are the same or different and are each independently an integer from 0 to 4; m is an integer from 0 to 500; and n is an integer from 1 to 500.

2. The flame retardant polyamide resin composition according to claim 1, comprising: about 100 parts by weight of the polyamide resin; about 1 part by weight to about 150 parts by weight of the filler; about 0.5 parts by weight to about 30 parts by weight of the flame retardant; and about 1 part by weight to about 40 parts by weight of the polyphenylene sulfide resin.

3. The flame retardant polyamide resin composition according to claim 1, wherein the flame retardant further comprises a phosphorus compound.

4. The flame retardant polyamide resin composition according to claim 3, wherein the phosphorus compound comprises a metal salt of phosphinic acid.

5. The flame retardant polyamide resin composition according to claim 3, including a weight ratio of the flame retardant polymer including a unit represented by Formula 1 and the phosphorus compound (polymer:phosphorus compound) of about 1:about 0.05 to about 1:about 20.

6. The flame retardant polyamide resin composition according to claim 1, wherein the polyamide resin is a polymer of a dicarboxylic acid component including a C₈ to C₂₀ aromatic dicarboxylic acid and a diamine component including a C₄ to C₂₀ aliphatic diamine.

7. The flame retardant polyamide resin composition according to claim 1, wherein the filler comprises organic filler, inorganic filler, or a combination thereof.

8. The flame retardant polyamide resin composition according to claim 7, wherein the organic filler comprises aramid fibers, and the inorganic filler comprises a fibrous fillers comprising carbon fibers, glass fibers, alkaline earth metal titanate fibers, silicon carbide fibers, wollastonite, and combinations thereof; powdery fillers comprising calcium carbide, silica, titanium oxide, carbon black, alumina, lithium carbonate, iron oxide, molybdenum bisulfide, graphite, glass beads, talc, clay micas, zirconium oxide, calcium silicate, boron nitride, and combinations thereof.

9. The flame retardant polyamide resin composition according to claim 1, wherein the sum of m and n ranges from 3 to 600.

10. The flame retardant polyamide resin composition according to claim 4, wherein the metal salt of phosphinic acid comprises a compound represented by Formula 2, Formula 3, or a combination thereof: 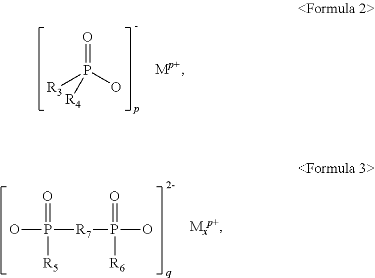
wherein R₃, R₄, R₅ and R₆ are the same or different and are each independently substituted or unsubstituted C₁ to C₆ alkyl, substituted or unsubstituted C₃ to C₆ cycloalkyl, or substituted or unsubstituted C₆ to C₁₂ aryl; R₇ is C₁ to C₁₀ alkylene or C₆ to C₁₀ arylene, alkyl-arylene, or aryl-alkylene; M is Al, Zn, Ca or Mg; p is 2 or 3; q is 1 or 3; and x is 1 or 2.

11. The flame retardant polyamide resin composition according to claim 4, wherein the metal salt of phosphinic acid comprises aluminum diethyl phosphinate, aluminum methylethyl phosphinate, or a combination thereof.

12. The flame retardant polyamide resin composition according to claim 1, wherein the flame retardant polyamide resin composition has a flame retardancy level of V-0 or higher, as measured on a 0.8 mm thick specimen in accordance with UL94 VB.

13. The flame retardant polyamide resin composition according to claim 1, wherein the flame retardant polyamide resin composition has a melting point (Tm) of about 280° C. to about 320° C. and a crystallization temperature (Tc) of about 250° C. to about 290° C.

14. A molded article produced from the flame-retardant polyamide resin composition according to claim 1.
